(19) United States
(12) Patent Application Publication
(10) Pub. No.: US 2007/0013487 A1
(43) Pub. Date: Jan. 18, 2007

(54) Digital certificate on connectors and other products using RFID tags and/or labels as well as RFID reader/interrogator

(76) Inventors: Jan Scholtz, Halstead (GB); Richard C.E. Durrant, Algonquin, IL (US)

Correspondence Address: Karl D. Kovach, Esq.;Stratos International, Inc., 7444 West Wilson Avenue, Chicago, IL, 60706, US

(21) Appl. No.: 11/183,525

(22) Filed: Jul. 18, 2005

(51) Int. Cl. H04Q 5/22

(52) U.S. Cl. 340/10.41; 340/572.1; 340/10.51; 439/488

(57) ABSTRACT

The device includes an authorized interrogator, a body, and a transponder attached to the body. The authorized interrogator includes a computer, an input device, an antenna, and a transceiver electrically connected to the antenna so as to form a reader/writer. The input device is used for inputting an authorization level of a user into the authorized interrogator by the user, and the input device is in communication with the computer. The authorized interrogator has preset levels of security corresponding to predefined categories of information. The user's authorization level corresponds to one level of security so that the user can gain access to the corresponding predefined category of information. In a first mode of operation, the transponder accepts information from the authorized interrogator. In a second mode of operation, the transponder delivers information to the authorized interrogator.

### BACKGROUND OF THE INVENTION

1. Field of the Invention

The present invention pertains to radio frequency identification devices. The invention more particularly concerns the management of a component or body, such as a connector, including the storage and updating of information related to events during the operational life of the component.

2. Discussion of the Background

Radio frequency identification devices (RFID) are known in the art. Typically, radio frequency identification systems incorporate an antenna or coil, a transceiver (with decoder), and a transponder (RF tag). Often times the antenna and the transceiver are packaged together so as to form a reader or interrogator. The transponder includes a transponder antenna and an integrated circuit chip attached to the transponder antenna. The antenna or coil emits a radio wave which induces an electrical current in the antenna of the transponder. The electrical current then activates the integrated circuit chip of the transponder. The integrated circuit chip can then transmit information through the antenna of the transponder via radio waves back to the antenna or coil. Information can be stored on the integrated circuit as either read only memory or read/write memory.

Radio frequency identification devices can be either active or passive. An active system includes a transponder which contains its own power source. In contrast, in a passive system the transponder obtains the energy from the radio waves emanating from the antenna or coil so as to enable the transponder to operate and transmit information. A transponder operating in accordance with the active system is able to transmit information to the antenna or coil over a greater distance than is a transponder operating in accordance with the passive system. However, the transponder operating in accordance with the active system is larger than the transponder operating in accordance with the passive system. Furthermore, typically transponders operating in accordance with the passive system contain integrated circuit chips that have read only memory. Examples of radio frequency identification components are presented in U.S. Pat. Nos. 5,206,626; 5,448,110; 6,118,379; 6,147,655; 6,424,263; 6,429,831; 6,445,297; 6,451,154; and 6,677,917. U.S. Pat. Nos. 5,206,626; 5,448,110; 6,118,379; 6,147,655; 6,424,263; 6,429,831; 6,445,297; 6,451,154; and 6,677,917 are hereby incorporated herein by reference.

Connectors and panels or patch panels are also known in the art. Known connectors include fiber optic connectors and electrically conductive connectors. An electrically conductive connector can be attached to electrically conductive cable such as copper based cable, or the electrical conductive connector can be integrated into a device such as an optoelectronic device. U.S. Pat. No. 6,350,063 discloses electrical connectors and cables, and an optoelectronic device. U.S. Pat. No. 6,350,063 is hereby incorporated herein by reference. FIG. 1 is a perspective view of an electrical connector 120 attached to an electrically conductive cable 122. Also shown is a complementary receptacle 130 into which the electrical connector 120 mates. FIG. 2 is a perspective view of another version of an electrical connector 140. The connector 140 is shown from a first perspective and a second perspective. FIG. 2 also discloses another version of a complementary receptacle 150. FIG. 3 is a perspective view of an optoelectronic device 160 which includes a fiber optic connector 170 and an electrical connector 180. The background material provided below concentrates on fiber optic connectors.

The front panel of a host device has many receptacles. Each receptacle accepts at least an individual fiber optic cable. The other end of the fiber optic cable connects to another device. The fiber optic cable can have a length of a few meters or of a few kilometers. A host device can accommodate a few hundred fiber optic cables. U.S. Pat. Nos. 5,233,674, and 5,481,634 disclose a fiber optic cable having a fiber optic connector. U.S. Pat. Nos. 5,233,674, and 5,481,634 are hereby incorporated herein by reference. FIG. 4 is a perspective view of a fiber optic cable 30 having a fiber optic connector 10. Attached to the fiber optic connector 10 is a strain relief boot 20. Formed as part of the optic connector is a release lever 40. FIG. 5 is a perspective view of the fiber optic cable 30 of FIG. 4 taken from another angle where a ferrule 50 is exposed. The fiber optic connector 10 conforms to the LC style of fiber optic connectors.

Experience has shown that a fiber optic cable can be inadvertently detached from the host device, or that the optical fiber within the fiber optic cable breaks and the fiber optic cable no longer transmits light energy to the host device. In such instances, a worker must go and look at the panel of the host device and determine which cable is no longer transmitting light signals to the host device either because the optical fiber is broken or the fiber optic cable is detached from the host device. When two or more fiber optic cables are malfunctioning, the worker's job becomes very burdensome and time consuming since there are hundreds of fiber optic cables to examine. Furthermore, a device or person is not receiving information conveyed by the malfunctioning fiber optic cable. Thus, organization of the cables, including the fiber optic cables and the copper based cables, in the vicinity of the panel is of great interest to the operators of the host devices.

Furthermore, in order to recoup the cost of the broken fiber optic cable, the operator of the system must look through paper work to verify if the broken fiber optic cable is still under warranty. Also, as part of the warranty process, the operator of the system may need to verify that the fiber optic cable was not used outside of its design parameters. Thus, the management of the fiber based system can be facilitated by being able to quickly find warranty documents related to components in the fiber based system, and to verify the use of the components.

### SUMMARY OF THE INVENTION

It is an object of the invention to provide a device or method which facilitates the identification of a specific connector or cable and to be able to retrieve information related to the life cycle of that specific connector or cable.

It is another object of the invention to provide a device or method which facilitates the identification of a specific connector or cable and to be able to retrieve warranty information related to that specific connector or cable.

It is yet another object of the invention to provide a device or method which facilitates the identification of a specific connector or cable and to be able to retrieve information related to the number of insertion cycles of the specific connector or cable.

It is still yet another object of the invention to provide a device or method which facilitates the identification of a specific connector or cable and to be able to retrieve information related to the number of rework instances, and the details of each rework instance including the identification if the person performing the rework, of the specific connector or cable.

It is yet still another object of the invention to provide a device or method which facilitates the identification of a specific connector or cable and to be able to retrieve information related to the upgrade history of the specific connector or cable.

In one form of the invention the method includes steps for imparting information in a transponder from an authorized interrogator by a user. The transponder is mechanically associated with a body, such as, for example, a fiber optic connector. The authorized interrogator has an antenna, and a transceiver. The transceiver is electrically connected to the antenna so as to form a reader/writer which is capable of activating and interrogating the transponder when the transponder is sufficiently close to the antenna. The authorized interrogator has preset levels of security corresponding to predefined categories of information, respectively. The user has an authorization level which corresponds to one level of security of the preset levels of security so that the user can gain access to one category of information of the predefined categories of information. The method includes the steps of: inputting the authorization level of the user into the authorized interrogator by the user; comparing the authorization level of the user against the preset levels of security stored in the authorized interrogator; permitting the user to have access, by the authorized interrogator, to the one category of information of the predefined categories of information which corresponds to the authorization level of the user; placing the body in sufficient proximity to the authorized interrogator so that the antenna of the authorized interrogator is capable of activating and interrogating the transponder; and transferring information associated with the one category of information from the authorized interrogator to the transponder so as to store the information associated with the one category of information with the transponder.

In another form of the invention the method includes steps for imparting information in an authorized interrogator from a transponder by a user. The transponder is mechanically associated with a body, such as, for example, a fiber optic connector. The authorized interrogator has an antenna, and a transceiver. The transceiver is electrically connected to the antenna so as to form a reader/writer which is capable of activating and interrogating the transponder when the transponder is sufficiently close to the antenna. The authorized interrogator has preset levels of security corresponding to predefined categories of information, respectively. The user has an authorization level which corresponds to one level of security of the preset levels of security so that the user can gain access to one category of information of the predefined categories of information. The method includes the steps of: inputting the authorization level of the user into the authorized interrogator by the user; comparing the authorization level of the user against the preset levels of security stored in the authorized interrogator; permitting the user to have access, by the authorized interrogator, to the one category of information of the predefined categories of information which corresponds to the authorization level of the user; placing the body in sufficient proximity to the authorized interrogator so that the antenna of the authorized interrogator is capable of activating and interrogating the transponder; and transferring information associated with the one category of information from the transponder to the authorized interrogator so as to store the information associated with the one category of information with the authorized interrogator.

In still yet another form of the invention, the device includes elements for having interaction with a user. The device includes: an authorized interrogator having preset levels of security corresponding to predefined categories of information, respectively, and wherein the user has an authorization level which corresponds to one level of security of the preset levels of security so that the user can gain access to one category of information of the predefined categories of information, the authorized interrogator including: a computer having a central processing unit, an input device for inputting the authorization level of the user into the authorized interrogator by the user, the input device in communication with the computer, an antenna, and a transceiver electrically connected to the antenna so as to form a reader/writer, the reader/writer in communication with the computer; a body; and a transponder mechanically associated with the body, and wherein, in a first mode of operation, the transponder accepts information from the authorized interrogator, and wherein, in a second mode of operation, the transponder delivers information to the authorized interrogator. Therefore, the information on the transponder acts as a digital certificate.

Thus, the invention achieves the objectives set forth above. The invention provides a device or method which is able to read or write useful information associated with a transponder of a body or component, such as, for example, a fiber optic connector. Useful information includes, but is not limited to, warranty information, insertion cycle history, rework information, and upgrade information. Therefore, the operator of the system does not spend time looking for paper documents to verify that the warranty exists and is still valid, and does not spend time looking for paper work associated with the past history of insertions and rework of the body having the transponder, since all of this information is available by interrogating the transponder of the body by the authorized interrogator.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a copper based electrical connector and a complementary receptacle, the electrical connector is attached to a copper based electrical cable;

FIG. 2 is a perspective view of another version of the electrical connector and complementary receptacle of FIG. 1;

FIG. 3 is a perspective view of an optoelectronic transceiver which has an optical connector end and an electrical connector end;

FIG. 4 is a perspective view of a known fiber optic cable and connector assembly;

FIG. 5 is a perspective view of the fiber optic cable and connector assembly of FIG. 4 taken from another angle;

FIG. 6 is a perspective view of the combination of the fiber optic cable and the transponder;

FIG. 7 is a perspective view of the combination of the fiber optic cable and the transponder of FIG. 6 taken from another angle;

FIG. 8 is a perspective view of an authorized interrogator;

FIG. 9 is a partial front view of a reader/writer of the authorized interrogator;

FIG. 10 is a partial side view of the reader/writer of FIG. 9;

FIG. 11 is an electrical schematic of the electro-magnetic interaction between the transponder and the reader/writer;

FIG. 12 is a perspective view of the combination of the electrically conductive, copper based cable of FIG. 1 and the transponder;

FIG. 13 is a perspective view of the combination of the electrically conductive, copper based cable of FIG. 2 and the transponder;

FIG. 14 is a perspective view of the combination of the optoelectronic device of FIG. 3 and the transponder;

FIG. 15 is a partial front view of a host device having apertures and coils or antennas; and

FIG. 16 is a partial side view of the body connected to the host device.

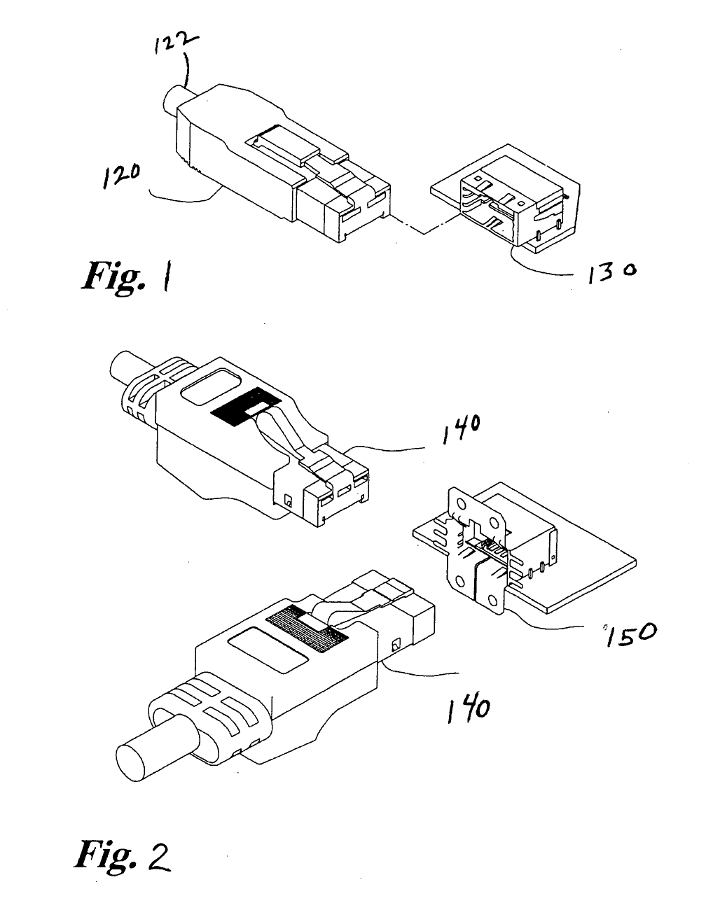

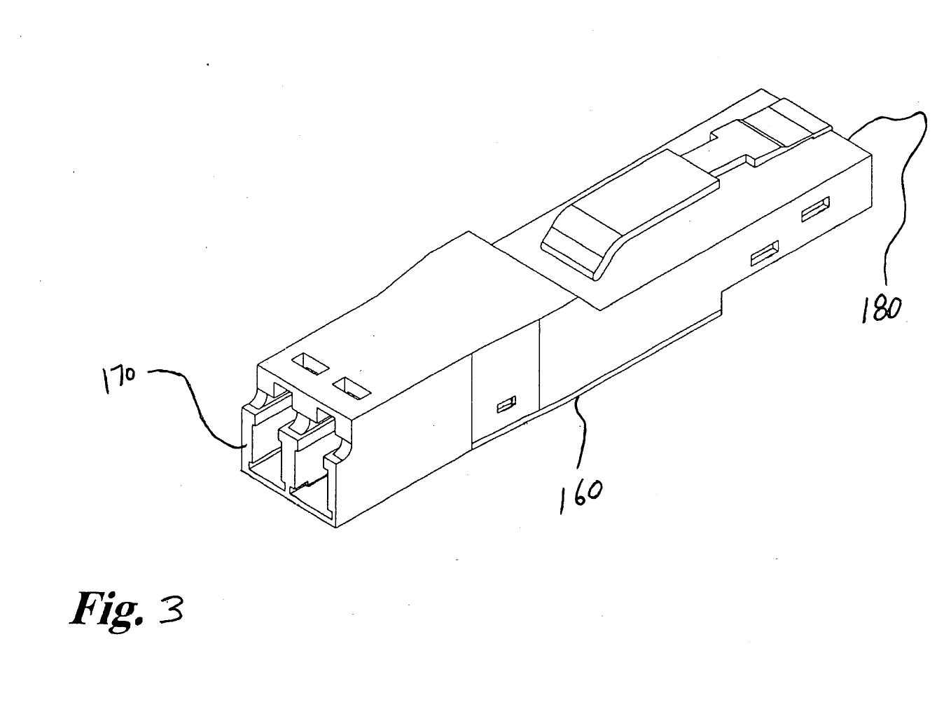

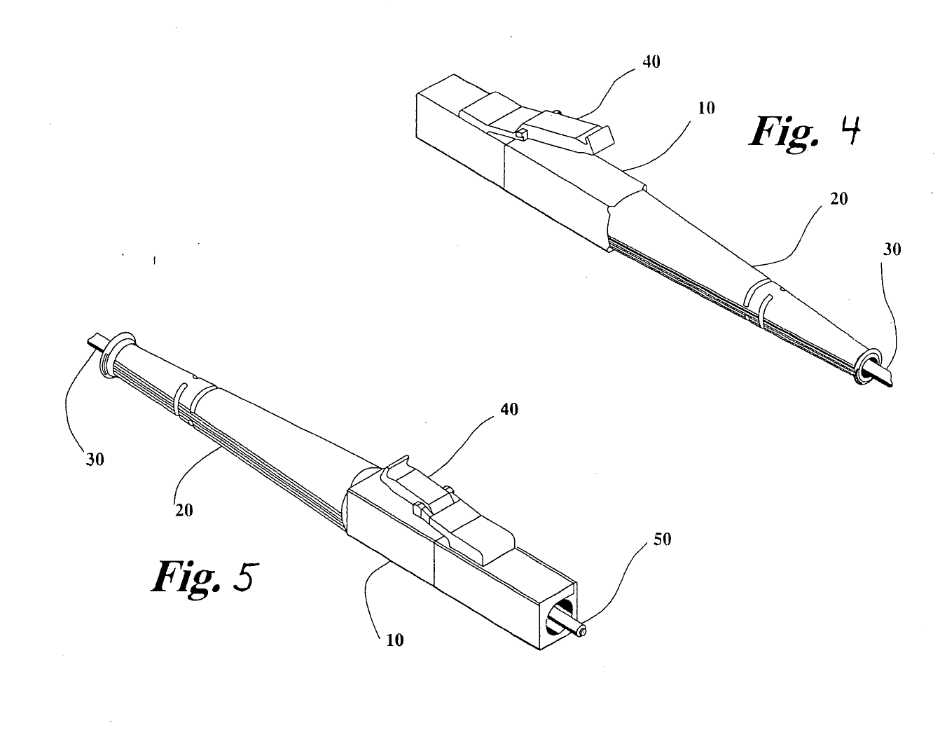

### DETAILED DESCRIPTION OF THE PRESENTLY PREFERRED EMBODIMENT

Referring now to the drawings, wherein like reference numerals designate identical or corresponding parts throughout the several views, and more particularly to FIGS. 6-16 thereof, embodiments of the present invention are displayed therein.

FIG. 6 is a perspective view of a fiber optic cable 30 having a fiber optic connector or body 10. The fiber optic connector 10 includes a release lever 40. Attached to the fiber optic connector 10 is a strain relief boot 20. Also attached to, or mounted on or in, the fiber optic connector 10 is a transponder 70. The transponder 70 can be affixed to the fiber optic connector 10 with an adhesive material or a clip (not shown). The clip physically squeezes or clamps the transponder 70 to the fiber optic connector 10. Alternatively, the transponder 70 can be insert molded into the body of the fiber optic connector 10. Furthermore, the transponder 70 can be attached to fiber optic connectors which are already in-service.

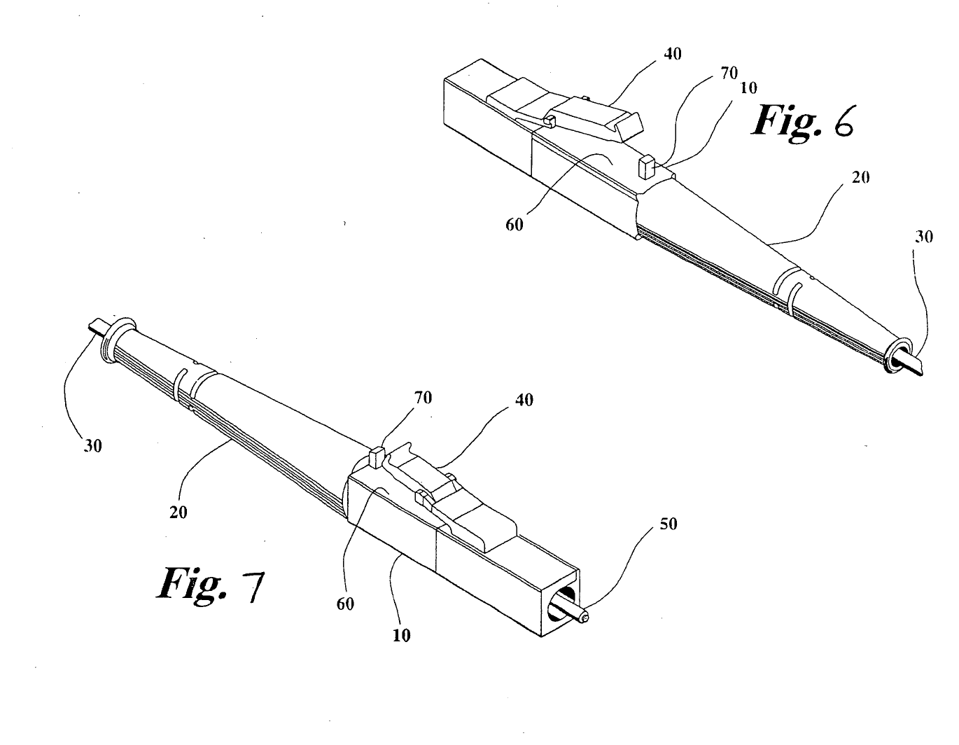

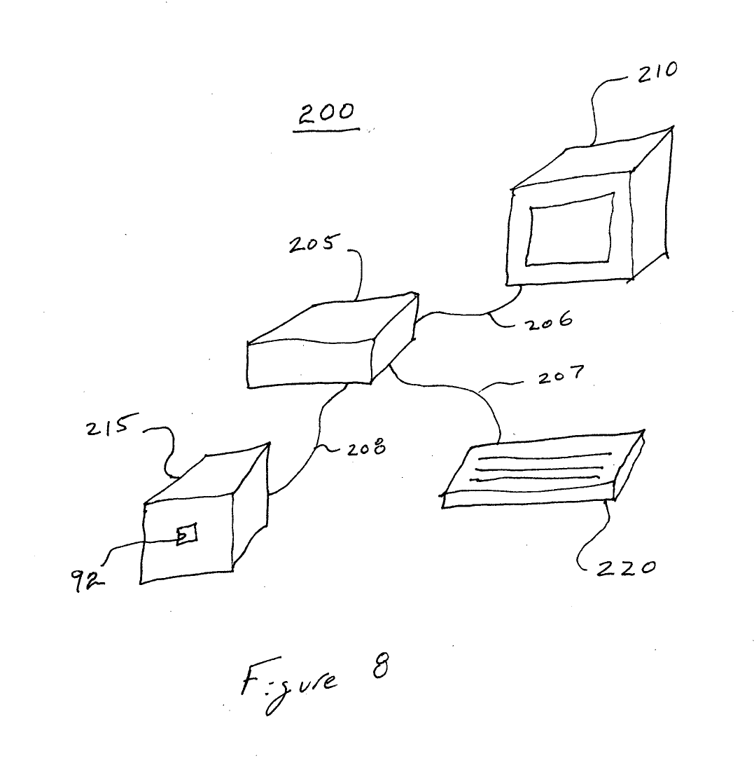

FIG. 7 is a perspective view of the fiber optic cable 30 of FIG. 6 taken from another angle. The view of the fiber optic cable 30 of FIG. 7 exposes the ferrule 50. The fiber optic connector 10 generally conforms to the LC standard, however, the fiber optic connector can also be constructed to conform to any other standard such as SC, and ST. The ferrule 50 is a single fiber ferrule, however multi-fiber ferrules and connectors can also be employed. Additionally, the fiber optic connector can be of its own unique design. Furthermore, the optical fiber terminated at the ferrule 50 can be any one of a single mode fiber, a multimode fiber, a polarization maintaining fiber, or any other type of optical fiber.

FIG. 8 is a perspective view of an authorized interrogator 200. The authorized interrogator 200 includes a computer 205 having a central processing unit (CPU), an optional monitor 210, an input device 220, and a reader/writer 215 having an aperture 92. The input device 220 can be a keyboard (as shown), a card reader, or some other data input device. The reader/writer 215 houses the antenna and transceiver. The input device 220 is in communication with the computer 205 via an electrical cable 207. The monitor 210 is in communication with the computer 205 via an electrical cable 206. The reader/writer 215 is in communication with the computer 205 via an electrical cable 208. The computer 205 helps to coordinate the activities of the various peripherals. Also, the computer 205 can store necessary information which can later be transferred to the reader/writer 215. The monitor 210 is not required, but may be used to ease the users verification or input and output information or data. The authorized interrogator 200 may take the form of a hand held device, where many of the components of the authorized interrogator 200 are merged or integrated with one another.

The authorized interrogator 200 has preset levels of security corresponding to predefined categories of information, respectively. The user of the authorized interrogator 200 has a pre-assigned authorization level which corresponds to one level of security of the preset levels of security so that the user can gain access to one category of information of the predefined categories of information. However, the user's authorization level may be such that the user can access multiple categories of information.

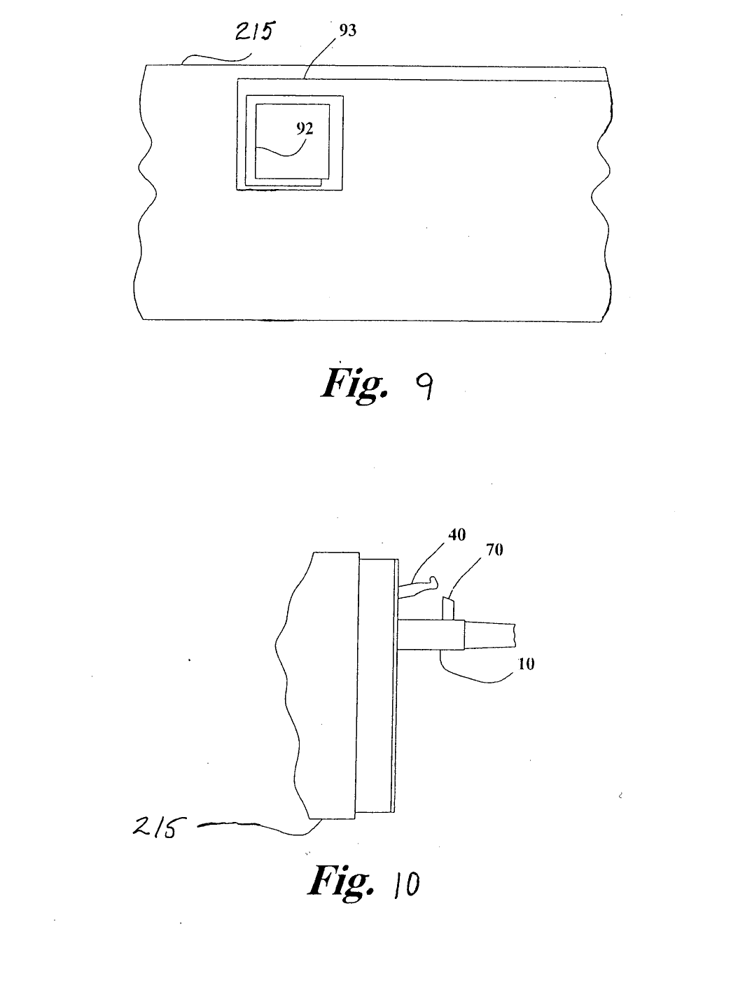

FIG. 9 is a partial front view of the reader/writer 215 around the aperture 92 showing a coil or antenna 93. The coil or antenna 93 surrounds the aperture 92. The coil or antenna 93 is made of a suitable electrically conductive material such as copper. The coil or antenna 93 is adhered to the surface of the reader/writer 215 or is attached to a substrate for mounting to the reader/writer 215. Typically, the coil or antenna 93 is attached to the substrate with an adhesive material. The substrate is typically made of non-conductive or insulative materials such as mylar or other suitable polymer materials. U.S. Pat. No. 4,972,050 discloses a method of constructing a substrate, where the substrate includes conductive paths such as coils or antennas. U.S. Pat. No. 4,972,050 is hereby incorporated herein by reference.

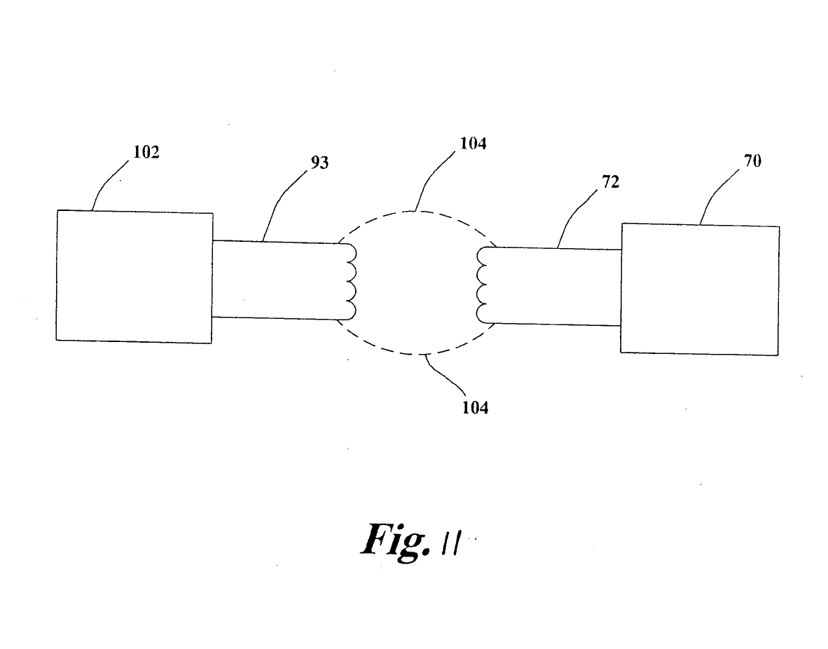

FIG. 10 is a partial side view of the reader/writer 215 where the fiber optic connector 10 is plugged into the reader/writer 215.

In practice, for example, a fiber optic connector 10 is inserted into and through aperture 92 of the authorized interrogator 200 so as to engage the fiber optic connector 10 with the authorized interrogator 200. Once installed, the antenna or coil 93 encircles a portion of the fiber optic connector 10. The transponder 70 is close enough to the antenna or coil 93 so that the radio waves, or electromagnetic power 104, emanating from antenna or coil 93 induce an electrical current in the transponder antenna 72 (see FIG. 11) of the transponder 70. The energy and frequency of the electrical signal running though the antenna or coil 93 is provided by a transceiver 102 (see FIG. 11) which is electrically connected to antenna or coil 93. The combination of an antenna and a transceiver is known as a reader/writer.

FIG. 11 is an electrical schematic of the electro-magnetic interaction between the transponder 70 and the antenna 93 and transceiver 102 of the reader/writer. Once the transponder 70 is energized by the power from the transceiver 102, the transponder sends information, which was previously stored on its integrated circuit chip, to the transceiver 102 via radio waves. The radio waves leave the transponder antenna 72 and are received by the antenna or coil 92. The induced electrical signal is then carried to the transceiver 102 for storage or manipulation of the data supplied by the transponder 70. Data may also be imparted on the transponder from the reader/writer 215, and, likewise, data may be imparted on the transceiver from the transponder.

Information stored in the transponder 70 includes information related to the life cycle of the connector or cable from the inception of the connector or cable until the time the connector or cable is no longer used. Examples of information which can be stored in the transponder 70 include the following information: the number of insertion cycles of the body 10 with the authorized interrogator 200; the number of rework instances of the body 10; the number of warranty rework instances of the body 10; the number of general refurbishment instances of the body 10; the number of upgrade history instances of the body 10; the length of the fiber optic cable 30 to which the transponder 70 is attached; the date of purchase of the fiber optic cable 30 to which the transponder 70 is attached; the type or style of fiber optic connector 10 to which the transponder 70 is attached; the type of warranty associated with the fiber optic cable 30 to which the transponder 70 is attached; the type, style, or grade of optic fiber housed within the fiber optic cable 30 to which the transponder 70 is attached; and/or a unique identification number or serialization number or code which uniquely identifies a specific fiber optic cable 30.

Additionally, the name of the assembler or operator performing the rework, warranty work, or upgrade work can be stored in the transponder 70. Furthermore, during the assembly or build of the connector or cable, the identification and source of component parts used to construct the connector or cable can be stored on the transponder 70 along with the identification of the assemblers and operators involved in the build of the device. Procedures used during the build can also be stored in the transponder 70. Once the connector cable is built, the connector or cable can be tested for compliance and operation characteristic, such as attenuation. The details of the testing procedures, operator, and test results can be stored in the transponder 70. The dates of performance of the build, testing, rework, refurbishment work, warranty work, and upgrade work can be stored in the transponder 70 along with any other significant dates during the life history of the connector or cable. The data stored on the transponder 70 can secured by being encrypted or coded with specific a key or keys to encode or decode the data.

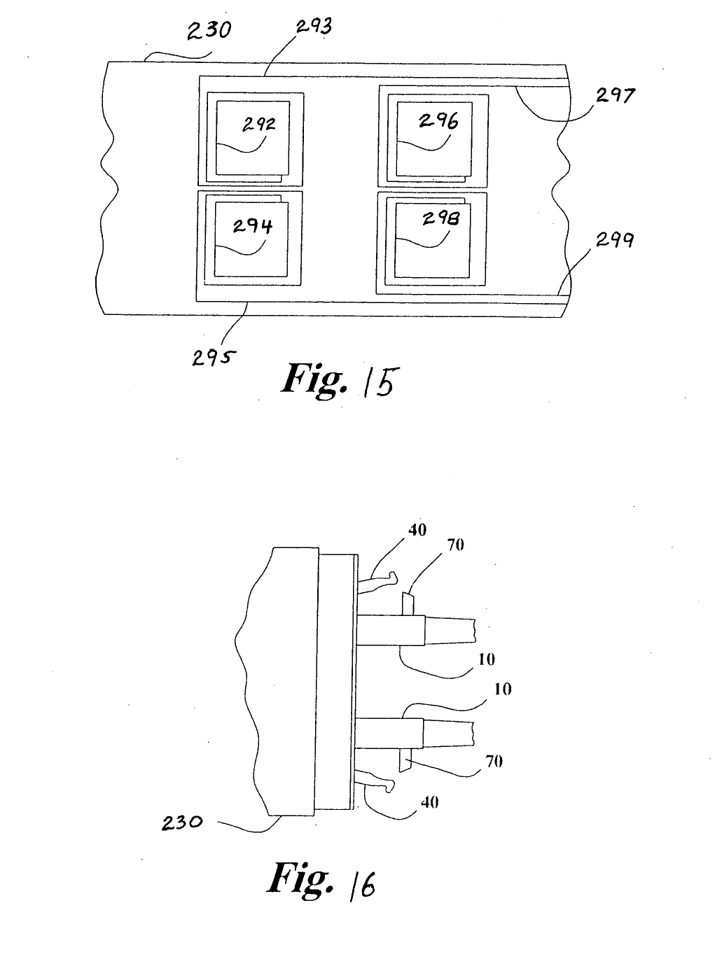

The number of insertion cycles of the body 10 with the authorized interrogator 200 is the number of times that the body 10 engages the authorized interrogator 200 as shown in FIG. 10. The number of insertion cycles of the body 10 with a host device can also be monitored. FIG. 15 is a partial front view of a host device 230 having apertures 292, 294, 296, and 298, and coils or antennas 293, 295, 297, and 299. FIG. 16 is a partial side view of the combination of more than one body 10 connected to the host device 230. The host device 230 includes multiple apertures 292, 294, 296, and 298, whereas the authorized interrogator 200 discloses one aperture 92. The authorized interrogator 200 may have more than one aperture. And, likewise, the host device 230 can be configured so as to act as an authorized interrogator. Operation of the host device 230 is disclosed in U.S. patent application having Ser. No. 10/816,749 which is hereby incorporated herein by reference.

The information and number of rework instances of the body 10 can be easily tracked. When the body 10 is reworked, the user places the body 10 in close proximity to the authorized interrogator 200 and then inputs information regarding the rework instance, such as the time and date of the rework, and specific details as to the rework issues.

The information and number of warranty rework instances of the body 10 can be easily tracked. When the body 10 is reworked under the warranty, the user places the body 10 in close proximity to the authorized interrogator 200 and then inputs information regarding the warranty rework instance, such as the time and date of the rework, specific details as to the rework issues, and the terms of the warranty. Also, the user can down load environmental data from the body, such as insertion cycles, to determine if the environmental data levels exceed the terms of the warranty. Furthermore, the terms of the warranty can be down loaded from the body 10.

The information and number of general refurbishment instances of the body 10 can be easily tracked. When the body 10 is refurbished, the user places the body 10 in close proximity to the authorized interrogator 200 and then inputs information regarding the general refurbishment instance, such as the time and date of the general refurbishment, and specific details as to the general refurbishment issues.

The information and number of upgrade history instances of the body 10 can be easily tracked. When the body 10 is upgraded, the user places the body 10 in close proximity to the authorized interrogator 200 and then inputs information regarding the upgrade instance, such as the time and date of the upgrade, and specific details as to the upgrade issues.

In a first mode of operation, when the user engages the authorized interrogator 200, the user inputs the user's authorization level into the authorized interrogator 200. Then, the authorized interrogator 200 compares the authorization level of the user against the preset levels of security stored in the authorized interrogator 200. If a corresponding comparison is made between the authorization level of the user and the preset levels of security stored in the authorized interrogator 200, then the user is permitted to have access, by the authorized interrogator 200, to the one category of information of the predefined categories of information. Next, the user places the body 10 in sufficient proximity to the authorized interrogator 200 so that the antenna 93 of the authorized interrogator 200 is capable of activating and interrogating the transponder 70. Thus, the information associated with the one category of information is transferred from the authorized interrogator 200 to the transponder 70 so as to store the information associated with the one category of information with the transponder 70.

In a second mode of operation, the steps discussed above are the same, but the information associated with the one category of information is transferred from the transponder 70 to the authorized interrogator 200 so as to store the information associated with the one category of information with the authorized interrogator 200. In either the first and/or second mode of operation, once the information has been transferred, the body 10 can go back to general use such with a host device, or be placed in inventory.

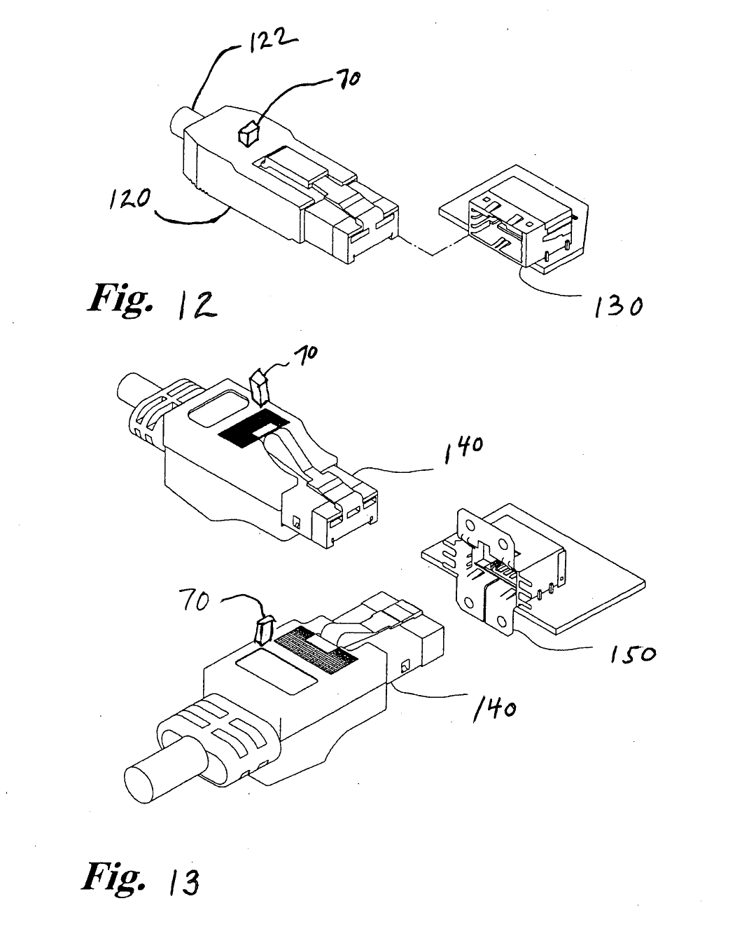

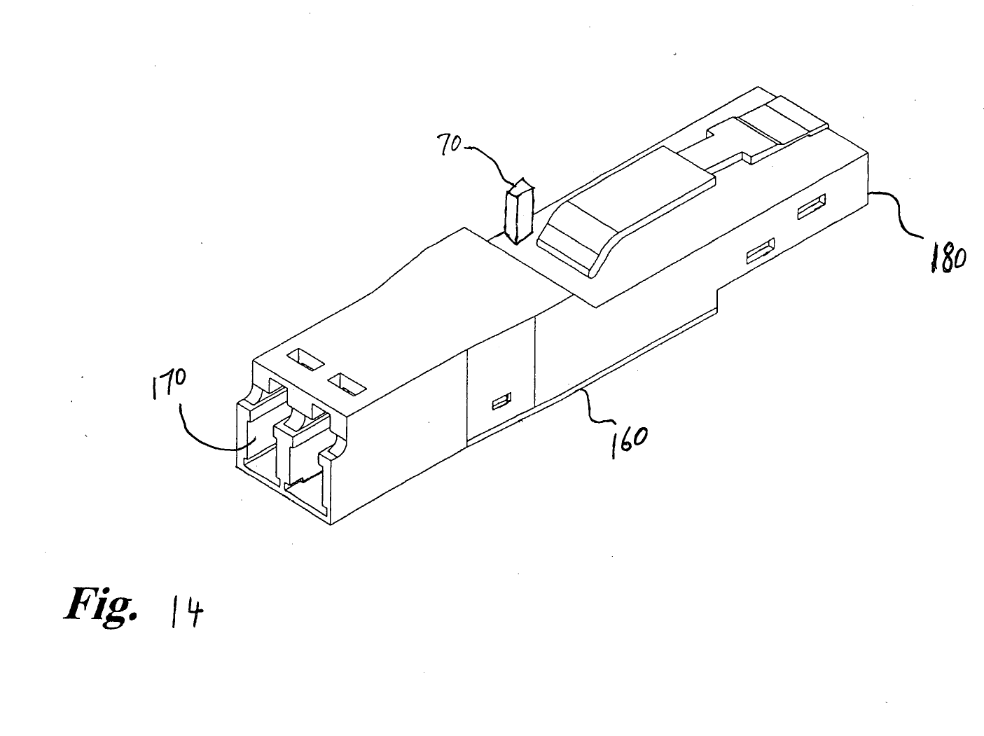

A second embodiment of the body is disclosed in FIGS. 12 and 13. FIG. 12 is a perspective view of an electrical connector 120 or body to which is attached a transponder 70. The electrical connector 120 mates with a receptacle 130 which is mounted behind a panel (not shown). The panel and, if necessary, the associated substrate are constructed and operate as discussed above in regard to the first embodiment of the invention. Thus, when the electrical connector 120 which is associated with the electrical cable 122 is plugged into the authorized interrogator, the antenna or coil associated with the authorized interrogator will receive information from the transponder 70 mounted to the electrical connector 120. The transponder 70 can be attached to the electrical connector 120 by way of an adhesive material, a clip, or the transponder 70 can be insert molded into the body of the electrical connector 120. The transponder 70 can be attached to electrical connectors out in the field.

FIG. 13 is a perspective view of another version of the electric connector shown in FIG. 12. FIG. 13 provides two perspective views of electric connector 140 or body to which is attached transponder 70. Also shown is receptacle 150 which accepts electrical connector 140. Again, the panel of the authorized interrogator is not shown for reasons of clarity. Note that the disclosed electrical connectors 120, 140 are used for illustration purposes only. The embodiment of the invention encompasses the attachment or mounting of a transponder to any type or style of electrical connector.

A third embodiment of the body is disclosed in FIG. 14. FIG. 14 is a perspective view of an optoelectronic device 160 or body to which is attached a transponder 70. The optoelectronic device 160 includes a fiber optic connector 170 and an electrical connector 180. In use, the optoelectronic device 160 has its electrical connector 180 attached to the authorized interrogator or host device through a panel of the device similar to the attachment of the optical fibers to the authorized interrogator as discussed above in the explanation of the first embodiment of the invention. Thus, the antenna associated with the panel activates the transponder 70 of the optoelectronic device 160. The transponder 70 can be attached to optoelectronic devices 160 which are in use, or the transponder 70 can be insert molded or mounted within the housing of the optoelectronic device 160. Note that the disclosed optoelectronic device 160 is used for illustration purposes only. The embodiment of the invention encompasses the attachment or mounting of a transponder to any type or style of optoelectronic device.

Obviously, numerous modifications and variations of the present invention are possible in light of the above teachings. It is therefore to be understood that within the scope of appended claims, the invention may be practiced otherwise than as specifically described herein.

1. A method for imparting information in a transponder from an authorized interrogator by a user, where the transponder is mechanically associated with a body, the authorized interrogator having an antenna, and a transceiver, the transceiver electrically connected to the antenna so as to form a reader/writer which is capable of activating and interrogating the transponder when the transponder is sufficiently close to the antenna, and where the authorized interrogator has preset levels of security corresponding to predefined categories of information, respectively, the user has an authorization level which corresponds to one level of security of the preset levels of security so that the user can gain access to one category of information of the predefined categories of information, the method comprising the steps of:
inputting the authorization level of the user into the authorized interrogator by the user;
comparing the authorization level of the user against the preset levels of security stored in the authorized interrogator;
permitting the user to have access, by the authorized interrogator, to the one category of information of the predefined categories of information which corresponds to the authorization level of the user;
placing the body in sufficient proximity to the authorized interrogator so that the antenna of the authorized interrogator is capable of activating and interrogating the transponder; and
transferring information associated with the one category of information from the authorized interrogator to the transponder so as to store the information associated with the one category of information with the transponder.

2. A method according to claim 1 wherein the predefined categories of information includes information related to a number of insertion cycles of the body with the authorized interrogator.

3. A method according to claim 2 wherein the predefined categories of information includes information related to a number of rework instances of the body.

4. A method according to claim 3 wherein the predefined categories of information includes information related to a number of warranty rework instances of the body.

5. A method according to claim 4 wherein the predefined categories of information includes information related to a number of general refurbishment instances of the body.

6. A method according to claim 5 wherein the predefined categories of information includes information related to a number of upgrade history instances of the body.

7. A method according to claim 6 wherein the body is a fiber optic connector.

8. A method for imparting information in an authorized interrogator from a transponder by the user, the transponder is mechanically associated with a body, the authorized interrogator having an antenna, and a transceiver, the transceiver electrically connected to the antenna so as to form a reader/writer which is capable of activating and interrogating the transponder when the transponder is sufficiently close to the antenna, and where the authorized interrogator has preset levels of security corresponding to predefined categories of information, respectively, the user has an authorization level which corresponds to one level of security of the preset levels of security so that the user can gain access to one category of information of the predefined categories of information, the method comprising the steps of:
inputting an authorization level of the user into the authorized interrogator by the user;
comparing the authorization level of the user against the preset levels of security stored in the authorized interrogator;
permitting the user to have access, by the authorized interrogator, to the one category of information of the predefined categories of information which corresponds to the authorization level of the user;
placing the body in sufficient proximity to the authorized interrogator so that the antenna of the authorized interrogator is capable of activating and interrogating the transponder; and
transferring information associated with the one category of information from the transponder to the authorized interrogator so as to store the information associated with the one category of information with the authorized interrogator.

9. A method according to claim 8 wherein the predefined categories of information includes information related to a number of insertion cycles of the body with the authorized interrogator.

10. A method according to claim 9 wherein the predefined categories of information includes information related to a number of rework instances of the body.

11. A method according to claim 10 wherein the predefined categories of information includes information related to a number of warranty rework instances of the body.

12. A method according to claim 11 wherein the predefined categories of information includes information related to a number of general refurbishment instances of the body.

13. A method according to claim 12 wherein the predefined categories of information includes information related to a number of upgrade history instances of the body.

14. A method according to claim 13 wherein the body is a fiber optic connector.

15. A device having interaction with a user, the device comprising:
an authorized interrogator having preset levels of security corresponding to predefined categories of information, respectively, and wherein the user has an authorization level which corresponds to one level of security of the preset levels of security so that the user can gain access to one category of information of the predefined categories of information, the authorized interrogator including:
a computer having a central processing unit,
an input device for inputting the authorization level of the user into the authorized interrogator by the user, the input device in communication with the computer,
an antenna, and
a transceiver electrically connected to the antenna so as to form a reader/writer, the reader/writer in communication with the computer;
a body; and
a transponder mechanically associated with the body, and wherein, in a first mode of operation, the transponder accepts information from the authorized interrogator, and wherein, in a second mode of operation, the transponder delivers information to the authorized interrogator.

16. The device according to claim 15 wherein the authorized interrogator includes a monitor in communication with the computer.

17. The device according to claim 16 wherein the input device of the authorized interrogator is a keyboard.

18. A device according to claim 17 wherein the body includes a fiber optic connector.

19. A device according to claim 18 wherein the transponder includes a transponder antenna and an integrated circuit chip attached to the transponder antenna.

20. A device according to claim 19 wherein the predefined categories of information includes information related to a number of insertion cycles of the body with the authorized interrogator.

21. A device according to claim 20 wherein the predefined categories of information includes information related to a number of rework instances of the body.

22. A device according to claim 21 wherein the predefined categories of information includes information related to a number of warranty rework instances of the body.

23. A device according to claim 22 wherein the predefined categories of information includes information related to a number of general refurbishment instances of the body.

24. A device according to claim 23 wherein the predefined categories of information includes information related to a number of upgrade history instances of the body.
